(19) United States
(12) Patent Application Publication
(10) Pub. No.: US 2026/0084241 A1
(43) Pub. Date: Mar. 26, 2026

(54) LASER APPARATUS

(71) Applicant: Samsung Display Co., LTD., Yongin-si (KR)

(72) Inventors: JONG-HEE LIM, Yongin-si (KR); JIHUN KANG, Yongin-si (KR); SEOK HWAN KIM, Yongin-si (KR); JAEIL KIM, Yongin-si (KR); JUNG-BIN KIM, Yongin-si (KR); HYOUNG-JOO KIM, Yongin-si (KR); ILYOUNG JEONG, Yongin-si (KR)

(21) Appl. No.: 19/219,105

(22) Filed: May 27, 2025

(30) Foreign Application Priority Data
Sep. 24, 2024 (KR) 10-2024-0129166

(51) Int. Cl. B23K 26/10; B23K 26/082; B23K 26/38

(52) U.S. Cl. CPC B23K 26/10; B23K 26/082; B23K 26/38

(57) ABSTRACT

A laser apparatus includes: a stage on which an object is loaded, where the stage defines a groove line which entirely overlaps a cutting line of the object in a plan view, and defining a first additional groove line which is at a periphery of the groove line, is spatially connected to the groove line, and is spaced apart from the cutting line in the plan view; a laser generating part which is arranged on the stage and emits a laser beam; and a scanner which is arranged on an optical path of the laser beam and radiates the laser beam toward the object.

This application claims priority to Korean Patent Application No. 10-2024-0129166, filed on Sep. 24, 2024, and all the benefits accruing therefrom under 35 U.S.C. § 119, the content of which in its entirety is herein incorporated by reference.

### BACKGROUND

### 1. Field

The present disclosure relates generally to a laser apparatus. More particularly, the present disclosure relates to a laser apparatus including a stage defining a groove line.

### 2. Description of the Related Art

A laser apparatus may perform processes such as marking, exposing, etching, punching, scribing, cutting, or the like on an object with a laser emitted from a laser generating part thereof. For example, the laser apparatus may perform a process of cutting a display device into a desired size and shape in a manufacturing process of the display device.

### SUMMARY

Embodiments provide a laser apparatus with improved process reliability.

A laser apparatus according to an embodiment of the present disclosure includes: a stage on which an object is loaded, where the stage defines a groove line which entirely overlaps a cutting line of the object in a plan view, and a first additional groove line which is at a periphery of the groove line, is spatially connected to the groove line, and is spaced apart from the cutting line in the plan view; a laser generating part which is arranged on the stage and emits a laser beam; and a scanner which is arranged on an optical path of the laser beam and radiates the laser beam toward the object.

In an embodiment, when the laser generating part is turned on from a turned-off state, the scanner may radiate the laser beam to the first additional groove line.

In an embodiment, before forming the cutting line at the object, the scanner may radiate the laser beam to the first additional groove line during a period of time in which a power of the laser beam is stabilized.

In an embodiment, the first additional groove line may be provided in plurality, and a plurality of first additional groove lines may be spatially connected to one side of the groove line and an opposite side opposite to the one side of the groove line, respectively.

In an embodiment, surfaces of the stage defining the first additional groove line may include an inclined surface in a cross-section.

In an embodiment, inner side surfaces of the stage defining the first additional groove line may include an uneven structure.

In an embodiment, the laser apparatus may further include a control part which controls the scanner. In such an embodiment, the scanner may include a shutter which blocks the laser beam emitted from the laser generating part and a shutter driver which controls the shutter to open or close in response to a signal provided from the control part.

In an embodiment, the scanner may radiate the laser beam to the groove line from a cutting start point to a cutting end point along the cutting line. In such an embodiment, the shutter may block the laser beam while an aiming point of the laser beam moves from the cutting end point to the cutting start point.

In an embodiment, the laser apparatus may further include a work table arranged under the stage and including a suction member which applies a suction force to the stage.

In an embodiment, the stage may include a body portion defining the groove line and the first additional groove line, a central supporting portion which is formed integrally with an upper surface of the body portion as a single unitary indivisible part and supports a central portion of the object, and a peripheral supporting portion which is arranged on the upper surface of the body portion to surround at least a portion of the central supporting portion in the plan view, and supports an edge portion of the object.

A laser apparatus according to an embodiment of the present disclosure includes: a stage on which an object is loaded, where the stage defines a groove line which entirely overlaps a cutting line of the object in a plan view, a first additional groove line which is at a periphery of the groove line, is spatially connected to the groove line, and is spaced apart from the cutting line in the plan view, and a second additional groove line at a periphery of the first additional groove line; a laser generating part which is arranged on the stage and emits a laser beam; and a scanner which is arranged on an optical path of the laser beam and radiates the laser beam toward the object. In such an embodiment, the scanner radiates the laser beam to the groove line from a cutting start point to a cutting end point along the cutting line. In such an embodiment, the scanner radiates the laser beam to the second additional groove line while an aiming point of the laser beam moves from the cutting end point to the cutting start point.

In an embodiment, when the laser generating part is turned on from a turned-off state, the scanner may radiate the laser beam to the first additional groove line.

In an embodiment, before forming the cutting line at the object, the scanner may radiate the laser beam to the first additional groove line during a period of time in which a power of the laser beam is stabilized.

In an embodiment, surfaces of the stage defining the second additional groove line may include an inclined surface in a cross-section.

In an embodiment, the second additional groove line may extend in a first direction, and the first additional groove line may extend in a second direction intersecting the first direction.

In an embodiment, the first additional groove line may be provided in plurality, and a plurality of first additional groove lines may include a first first additional groove line spatially connected to one side of the groove line and a second first additional groove line spatially connected to an opposite side opposite to the one side of the groove line.

In an embodiment, the first first additional groove line and the second first additional groove line may be spaced apart from each other. In such an embodiment, the second additional groove line may connect the first first additional groove line and the second first additional groove line.

In an embodiment, surfaces of the stage defining the first additional groove line may include an inclined surface in a cross-section.

In an embodiment, the stage may include a body portion defining the groove line, the first additional groove line, and the second additional groove line, a central supporting portion which is formed integrally with an upper surface of the body portion as a single unitary indivisible part and supports a central portion of the object, and a peripheral supporting portion which is arranged on the upper surface of the body portion to surround at least a portion of the central supporting portion in the plan view, and supports an edge portion of the object.

In an embodiment, the laser apparatus may further include a work table arranged under the stage and including a suction member which applies a suction force to the stage and a control part which controls the scanner.

A laser apparatus according to an embodiment of the present disclosure may include a stage on which an object is loaded, a laser generating part which is arranged on the stage and emits a laser beam, and a scanner which is arranged on an optical path of the laser beam and radiates the laser beam toward the object. The stage may define a groove line which entirely overlaps a cutting line of the object in a plan view and a first additional groove line which is spatially connected to the groove line and is spaced apart from the cutting line in a plan view.

In such an embodiment, before forming the cutting line at the object, when the laser generating part is turned on from a turned-off state, the scanner may radiate the laser beam to the first additional groove line. That is, the scanner may radiate the laser beam to the first additional groove line during a period of time in which the power of the laser beam is stabilized.

In such an embodiment, as the first additional groove line is formed on the stage, the stage may be effectively prevented from being damaged by the laser beam in a process of radiating the laser beam to the first additional groove line. By forming the cutting line in a state in which the power of the laser beam is stabilized, the process reliability of forming the cutting line at the object may be improved.

### BRIEF DESCRIPTION OF THE DRAWINGS

Illustrative, non-limiting embodiments will be more clearly understood from the following detailed description in conjunction with the accompanying drawings.

FIG. 1 is a view illustrating a laser apparatus according to an embodiment of the present disclosure.

FIG. 2 is a cross-sectional view illustrating an example of an object processed by the laser apparatus of FIG. 1.

FIG. 3 is a view illustrating a scanner included in the laser apparatus of FIG. 1.

FIG. 4 is a perspective view illustrating the laser apparatus of FIG. 1.

FIG. 5 is a plan view illustrating a stage included in the laser apparatus of FIG. 1.

FIG. 6 is an enlarged plan view of area A of FIG. 5.

FIG. 7 is a cross-sectional view illustrating an example of a cross-section cut along line I-I′ of FIG. 6.

FIG. 8 is a cross-sectional view illustrating another example of a cross-section cut along line I-I′ of FIG. 6.

FIG. 9 is a plan view for describing an embodiment of a cutting process using the laser apparatus of FIG. 1.

FIG. 10 is a view illustrating a laser apparatus according to an embodiment of the present disclosure.

FIG. 11 is a view illustrating a scanner included in the laser apparatus of FIG. 10.

FIG. 12 is a plan view for describing an embodiment of a cutting process using the laser apparatus of FIG. 10.

FIG. 13 is a view illustrating a laser apparatus according to an embodiment of the present disclosure.

FIG. 14 is a plan view illustrating a stage included in the laser apparatus of FIG. 13.

FIG. 15 is a plan view for describing a cutting process using the laser apparatus of FIG. 13.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present disclosure will be described in detail with reference to the accompanying drawings. The same reference numerals are used for the same components in the drawings, and any repetitive detailed descriptions of the same components will be omitted or simplified.

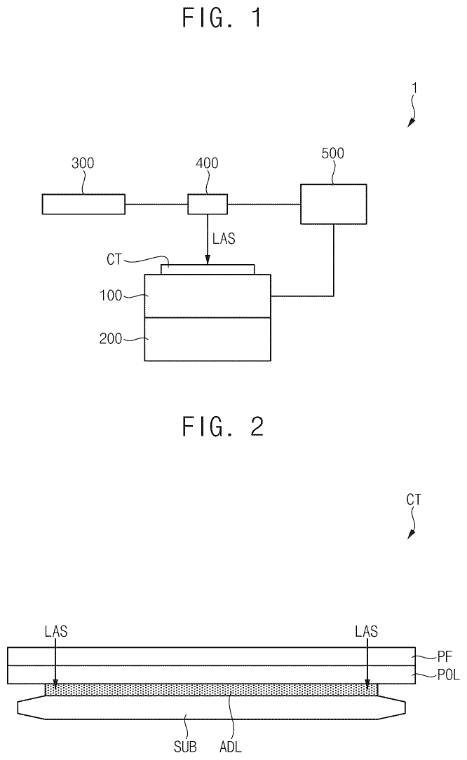

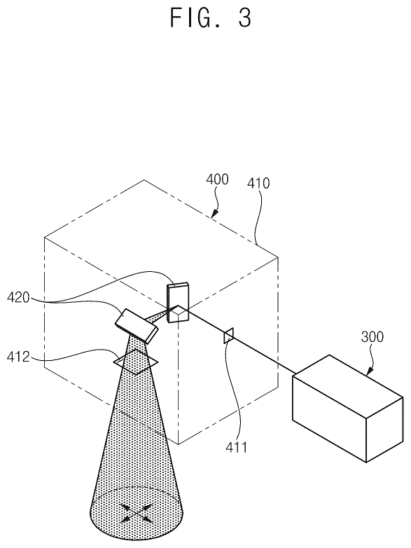

FIG. 1 is a view illustrating a laser apparatus according to an embodiment of the present disclosure. FIG. 2 is a cross-sectional view illustrating an example of an object processed by the laser apparatus of FIG. 1. FIG. 3 is a view illustrating a scanner included in the laser apparatus of FIG. 1.

Referring to FIGS. 1, 2, and 3, a laser apparatus 1 according to an embodiment of the present disclosure may include a stage 100, a work table 200, a laser generating part 300, a scanner 400, and a control part 500.

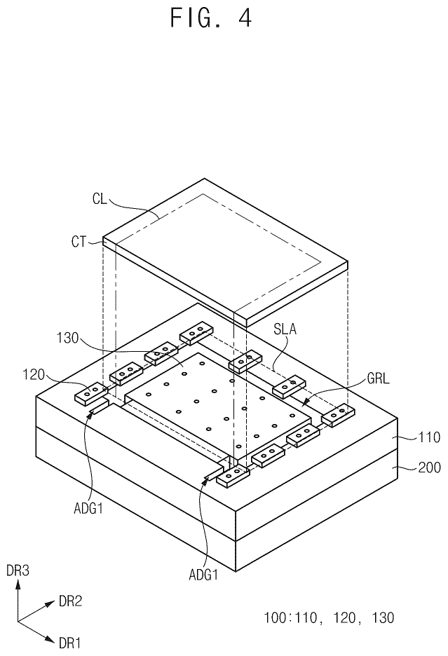

The laser apparatus 1 may be used for a marking process or a cutting process. In an embodiment, for example, the laser apparatus 1 may form a cutting line (CL, refer to FIG. 4) or a guide line by radiating a laser beam LAS on an object CT, and may cut the object CT. However, the present disclosure is not limited thereto, and the laser apparatus 1 may perform various processes depending on the type and use of the object CT.

The object CT may be arranged on the stage 100. In an embodiment, for example, the object CT may be loaded on an upper surface of the stage 100. In an embodiment, the object CT may include a substrate SUB, an adhesive layer ADL, an anti-reflection layer POL, and a protective film PF that are sequentially stacked. The substrate SUB may include a transparent material or an opaque material. In an embodiment, for example, the substrate SUB may include glass, sapphire, plastic, or the like. The adhesive layer ADL may attach the substrate SUB and the anti-reflection layer POL. In an embodiment, for example, the adhesive layer ADL may include a pressure sensitive adhesive (PSA) film, an optically clear adhesive (OCA) film, an optically clear adhesive resin (OCR), or the like. In an embodiment, for example, the anti-reflection layer POL may include a polarizer and a phase retarder. The protective film PF may cover the anti-reflection layer POL. The protective film PF may protect the anti-reflection layer POL in a subsequent process. In an embodiment, for example, the protective film PF may include polyethylene terephthalate (PET), polyimide (PI), polyethylene naphthalate (PEN), or the like. These may be used alone or in combination with each other. However, the present disclosure is not limited thereto, and the configuration of the object CT may be varied according to embodiments.

The stage 100 may support the object CT. The laser beam LAS generated by the laser generating part 300 may be radiated to the object CT loaded on the stage 100. The laser apparatus 1 may further include a stage transfer part that moves the stage 100. In an embodiment, as the stage transfer part moves the stage 100, the laser beam LAS may be radiated along the cutting line. However, the present disclosure is not limited thereto. In an embodiment, for example, the laser beam LAS may be radiated along the cutting line by moving only the laser generating part 300 and the scanner 400 as described below. In another embodiment, for example, the laser beam LAS may be radiated along the cutting line by moving all of the stage 100, the laser generating part 300 and the scanner 400.

The work table 200 may be arranged under the stage 100. In an embodiment, for example, an upper surface of the work table 200 may be coupled with a lower surface of the stage 100 through a coupling member. The work table 200 may include a suction member. That is, the suction member may suck a fluid, and the work table 200 may apply a suction force to the stage 100. In an embodiment, for example, a plurality of through holes may be defined or formed through the stage 100 in a thickness direction (e.g., the third direction DR3), and the suction member may suck the fluid (or gas) through the plurality of through holes. That is, as the suction member is driven, a suction force may be applied to a lower surface of the object CT through the plurality of through holes connected to the suction member. Accordingly, the object CT may be adsorbed and fixed on the stage 100.

The laser generating part 300 may be arranged on the stage 100. The laser generating part 300 may generate and emit the laser beam LAS. In an embodiment, for example, the laser beam LAS generated by the laser generating part 300 may be a CO₂ laser, an infrared laser, an ultraviolet laser, or the like, but the present disclosure is not limited thereto.

The scanner 400 may be arranged on the stage 100. The scanner 400 may be arranged on an optical path of the laser beam LAS emitted from the laser generating part 300. That is, the laser beam LAS emitted from the laser generating part 300 may enter an interior of the scanner 400. In an embodiment, as illustrated in FIG. 3, the scanner 400 may include a housing 410 and a mirror portion 420 arranged inside the housing 410.

The housing 410 may configure an outer shape of the scanner 400. A light entrance 411 may be defined on one surface of the housing 410. The light entrance 411 may serve as a passage through which the laser beam LAS emitted from the laser generating part 300 enters an interior of the housing 410.

The mirror portion 420 may reflect the laser beam LAS that enters the interior of the housing 410 through the light entrance 411. The laser beam LAS reflected by the mirror portion 420 may proceed toward the object CT.

A light radiation opening 412 may be defined on another surface, which is different from the one surface, of the housing 410. The light radiation opening 412 may serve as a passage through which the laser beam LAS reflected by the mirror portion 420 is emitted to an outside of the housing 410.

The laser apparatus 1 may further include a scanner transfer part that moves the laser generating part 300 and the scanner 400. As the scanner transfer part moves the laser generating part 300 and the scanner 400, the laser beam LAS may be radiated along the cutting line.

The control part 500 may control the overall operation of the laser apparatus 1. In an embodiment, for example, the control part 500 may control the stage transfer part, the laser generating part 300, the scanner 400, and the scanner transfer part. In an embodiment, the control part 500 may control the cutting process of the object CT using information such as a shape of the cutting line, a thickness of the object CT, and a position of the stage 100, or the like.

In an embodiment, the control part 500 may adjust a light penetration thickness (or light penetration depth) of the laser beam LAS into the object CT. That is, the laser beam LAS generated from the laser generating part 300 may be radiated to the object CT via the scanner 400, and the control part 500 may control various features (e.g., radiation time, wavelength, beam shape or intensity, etc.) of the laser beam LAS radiated to the object CT to adjust the light penetration thickness thereof in the object CT. In an embodiment, for example, as illustrated in FIG. 2, the laser beam LAS may be controlled to penetrate only the protective film PF and the anti-reflection layer POL. In such an embodiment, the laser beam LAS may be controlled to penetrate about half of a thickness of the adhesive layer ADL, and not to penetrate the substrate SUB. However, the present disclosure is not limited thereto.

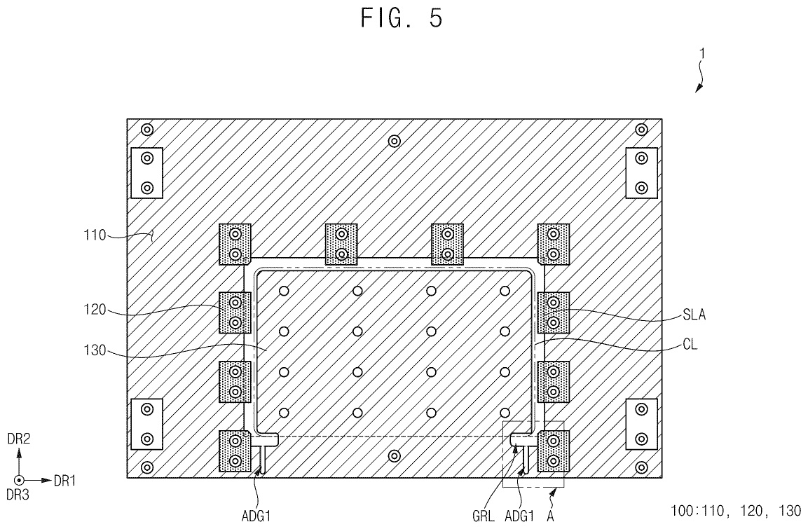

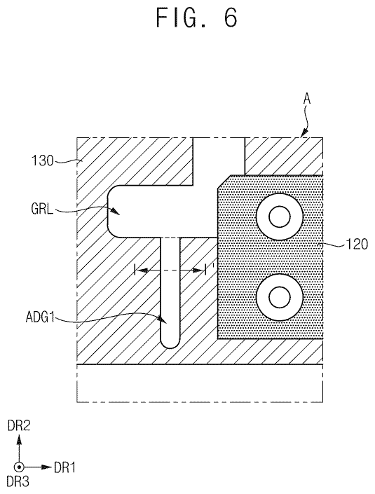

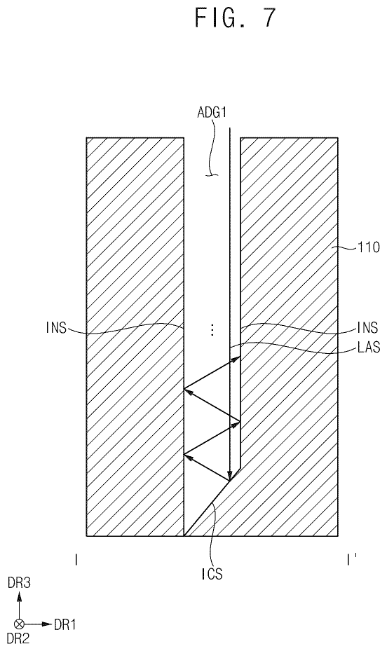

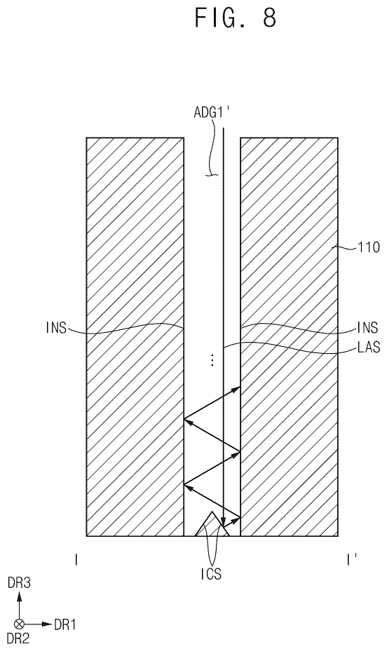

FIG. 4 is a perspective view illustrating the laser apparatus of FIG. 1. FIG. 5 is a plan view illustrating a stage included in the laser apparatus of FIG. 1. FIG. 6 is an enlarged plan view of area A of FIG. 5. FIG. 7 is a cross-sectional view illustrating an example of a cross-section cut along line I-I′ of FIG. 6. FIG. 8 is a cross-sectional view illustrating another example of a cross-section cut along line I-I′ of FIG. 6.

In the present disclosure, a plane may be defined by a first direction DR1 and a second direction DR2 intersecting the first direction DR1. For example, the first direction DR1 and the second direction DR2 may be perpendicular to each other. A direction normal to the plane, that is, a thickness direction of the stage 100 may be the third direction DR3. In other words, the third direction DR3 may be perpendicular to each of the first direction DR1 and the second direction DR2. As used herein the “plan view” is a view in the third direction DR3.

Referring to FIGS. 4, 5, and 6, in an embodiment, the stage 100 may include a body portion 110, a peripheral supporting portion 120, and a central supporting portion 130. A substrate loading area SLA may be defined as an area where the object CT is loaded on an upper surface of the stage 100.

A cutting line CL may be defined as a line along which the laser beam (LAS, refer to FIG. 1) is to be radiated on the object CT. In an embodiment, as illustrated in FIG. 4, the cutting line CL may have a rectangular planar shape with one side open in a plan view. However, the present disclosure is not limited thereto, and the planar shape of the cutting line CL may be varied according to embodiments. In an embodiment, as illustrated in FIG. 5, the cutting line CL may have a rectangular planar shape with one side open and rounded corners in a plan view.

The peripheral supporting portion 120 may be arranged on an upper surface of the body portion 110. The peripheral supporting portion 120 may be provided in plurality, and the plurality of peripheral supporting portions 120 may surround at least a portion of the central supporting portion 130 in a plan view. The peripheral support portions 120 may overlap an edge portion of the substrate loading area SLA in the third direction DR3. The peripheral supporting portions 120 may support an edge portion of the object CT. Here, the edge portion of the object CT may refer to a portion of the object CT located outside the cutting line CL. In an embodiment, for example, a plurality of through holes may be defined or formed in the peripheral supporting portions 120, and a suction force may be applied to the edge portion of the object CT through the plurality of through holes connected to the suction member of the work table 200.

The central supporting portion 130 may be arranged on the upper surface of the body portion 110. In an embodiment, for example, the central supporting portion 130 may be a portion of the upper surface of the body portion 110. That is, the central supporting portion 130 may be integrally formed with the upper surface of the body portion 110 as a single unitary indivisible part. The central supporting portion 130 may be spaced apart from the peripheral supporting portion 120. The central supporting portion 130 may overlap a central portion of the substrate loading area SLA in the third direction DR3. The central supporting portion 130 may support a central portion of the object CT. Here, the center portion of the object CT may refer to a portion of the object CT located inside the cutting line CL. In an embodiment, for example, a plurality of through holes may be defined or formed in the central supporting portion 130, and a suction force may be applied to the central portion of the object CT through the plurality of through holes connected to the suction member of the work table 200.

A groove line GRL may be defined on the upper surface of the body portion 110. The groove line GRL may be defined as a line of grooves dug to a depth (e.g., a predetermined depth) at the upper surface of the body portion 110. In an embodiment, the groove line GRL may be defined by a recessed portion of the stage 100 in the thickness direction of the stage 100 (e.g., the third direction DR3). The groove line GRL may be formed between the peripheral supporting portion 120 and the central supporting portion 130. In an embodiment, for example, the groove line GRL may have a shape of a portion of a rectangle in a plan view. In an embodiment, the groove line GRL may have a rectangular planar shape with one side open (partially open) in a plan view. However, the present disclosure is not limited thereto, and the planar shape of the groove line GRL may be varied in consideration of the planar shape of the cutting line CL.

The groove line GRL may entirely overlap the cutting line CL in a plan view. As the groove line GRL is defined or formed on the upper surface of the body portion 110, the stage 100 may be effectively prevented from being damaged by the laser beam in the process of forming the cutting line CL at the object CT.

In an embodiment, a first additional groove line ADG1 may be defined on the upper surface of the body portion 110. The first additional groove line ADG1 may be defined as a line of grooves dug to a depth (e.g., a predetermined depth) at the upper surface of the body portion 110. In an embodiment, the first additional groove line ADG1 may be defined by a recessed portion of the stage 100 in the thickness direction of the stage 100 (e.g., the third direction DR3).

The first additional groove line ADG1 may be defined or formed at a periphery of the groove line GRL and may be spatially connected to the groove line GRL. In an embodiment, for example, the first additional groove line ADG1 may extend in the second direction DR2. In an embodiment, the first additional groove line ADG1 may be integrally formed with the groove line GRL as a single unitary and indivisible part.

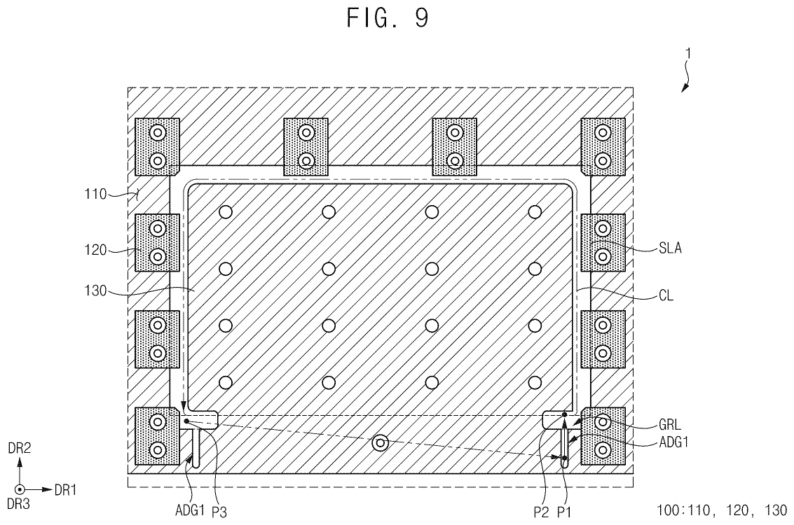

The first additional groove line ADG1 may be spaced apart from the cutting line CL in a plan view. In addition, the first additional groove line ADG1 may be spaced apart from the substrate loading area SLA. Before the process of forming the cutting line CL at the object CT, the laser beam may be radiated to the first additional groove line ADG1. That is, before the process of forming the cutting line CL at the object CT, the laser beam may be radiated to the first additional groove line ADG1 while the power of the laser beam is stabilized. A detailed description thereof will be provided below with reference to FIG. 9. In such an embodiment, as the first additional groove line ADG1 is defined on the upper surface of the body portion 110, the stage 100 may be effectively prevented from being damaged by the laser beam in the process of radiating the laser beam to the first additional groove line ADG1.

In an embodiment, the first additional groove line ADG1 may be provided in plurality, and the plurality of the first additional groove lines ADG1 may be respectively adjacent to one side of the groove line GRL and another side different from the one side of the groove line GRL (or an opposite side of the groove line GRL opposite to the one side in the first direction DR1) in a plan view. The first additional groove lines ADG1 may be spatially connected to the one side of the groove line GRL and the opposite side of the groove line GRL, respectively. In an embodiment, for example, where the groove line GRL has a rectangular planar shape with one side open in a plan view, the first additional groove lines ADG1 may be respectively adjacent to a first end of the groove line GRL and a second end opposite to the first end of the groove line GRL in a plan view.

Referring further to FIGS. 7 and 8, in an embodiment, the first additional groove line ADG1 (or ADG1′) may include at least one inclined surface ICS (i.e., a surface inclined with respect to inner side surfaces defining the first additional groove line ADG1 (or ADG1′)) in a cross-section to induce diffuse reflection of the laser beam LAS incident on inner surfaces defining the first additional groove line ADG1 (or ADG1′). Herein, surfaces defining a groove will be referred to as surfaces of the groove.

In an embodiment, for example, as illustrated in FIG. 7, the surfaces defining the first additional groove line ADG1 may include one inclined surface ICS in a cross-section. However, the present disclosure is not limited thereto, and as illustrated in FIG. 8, the surfaces defining the first additional groove line ADG1′ may include two or more inclined surfaces ICS in a cross-section.

The laser beam LAS incident on the first additional groove line ADG1 (or ADG1′) may be reflected multiple times inside the first additional groove line ADG1 (or ADG1′). That is, after the laser beam LAS is reflected from the inclined surface ICS of the first additional groove line ADG1 (or ADG1′), the laser beam LAS may be reflected on inner side surfaces INS of the stage 100 (specifically, the body portion 110) defining the first additional groove line ADG1 (or ADG1′). As the laser beam LAS is reflected multiple times inside the first additional groove line ADG1 (or ADG1′), a travel direction of the laser beam LAS may differ from a travel direction of the laser beam LAS previously incident on the first additional groove line ADG1 (or ADG1′). In addition, as the laser beam LAS is reflected multiple times inside the first additional groove line ADG1 (or ADG1′), the energy of the laser beam LAS may be reduced as the laser beam LAS collides with the inner side surfaces INS of the stage 100 (specifically, the body portion 110). Accordingly, the equipment included in the laser apparatus 1 may be effectively prevented from being damaged by the laser beam LAS.

In an embodiment, the inner side surfaces INS of the stage 100 (specifically, the body portion 110) defining the first additional groove line ADG1 (or ADG1′) may include an uneven structure or an uneven surface portion. In such an embodiment, the laser beam LAS may be relatively more diffusely reflected on the inner side surfaces INS of the body portion 110.

FIG. 9 is a plan view for describing an embodiment of a cutting process using the laser apparatus of FIG. 1.

Referring to FIG. 9, before forming the cutting line CL at the object (CT, refer to FIG. 4), the laser beam (LAS, refer to FIG. 1) may be radiated to the first additional groove line ADG1. In an embodiment, for example, where a second point P2 is a cutting start point of the object, a first point P1 of the first additional groove line ADG1 adjacent to the second point P2 may be a point at which the radiation of the laser beam starts. That is, the first point P1 may be referred to as a radiation start point, and the second point P2 may be referred to as a cutting start point.

When the laser generating part (300, refer to FIG. 1) is turned on from a turned-off state, the power of the laser beam emitted from the laser generating part may be relatively unstable. To perform the process of forming the cutting line CL in a state in which the power of the laser beam is stabilized, the process of forming the cutting line CL may be performed after the laser generating part is turned on for a period (e.g., a predetermined period) of time. The laser beam may be radiated to the first additional groove line ADG1 during the period (e.g., the predetermined period) of time in which the power of the laser beam is stabilized. That is, when the laser generating part is turned on from the turned-off state, the laser beam may be radiated to the first point P1, and during the period (e.g., the predetermined period) of time in which the power of the laser beam is stabilized, an aiming point of the laser beam (i.e., a point to which the laser beam is radiated) may move in the second direction DR2 from the first point P1.

In a state in which the power of the laser beam is stabilized, the laser beam may be radiated to the second point P2, and the process of forming the cutting line CL at the object may be performed. By forming the cutting line CL in a state in which the power of the laser beam is stabilized, the process reliability of forming the cutting line CL at the object may be improved. In an embodiment, for example, the cutting line CL may include a first short side connected to the second point P2 and extending in the second direction DR2, a long side connected to the first short side and extending in an opposite direction of the first direction DR1, and a second short side connected to the long side and a third point P3 and extending in an opposite direction of the second direction DR2. A first end of the cutting line CL may be the second point P2, and a second end opposite to the first end of the cutting line CL may be the third point P3. The laser beam may be radiated along the first short side, the long side, and the second short side to form the cutting line CL, and when the aiming point of the laser beam moves to the third point P3, the process of forming the cutting line CL at the object may be terminated. That is, the third point P3 may be referred to as a cutting end point.

In an embodiment, when the aiming point of the laser beam moves to the third point P3, the laser generating part may be turned off. In a state where the laser generating part is turned off, the aiming point of the laser beam may move from the third point P3 to the first point P1. That is, while the aiming point of the laser beam moves from the third point P3 to the first point P1, the laser generating part may not emit the laser beam.

When the aiming point of the laser beam moves from the third point P3 to the first point P1, the laser generating part may be turned on again from the turned-off state. After the laser generating part is turned on again, the process of stabilizing the power of the laser beam and the process of forming the cutting line CL on the object may be performed again.

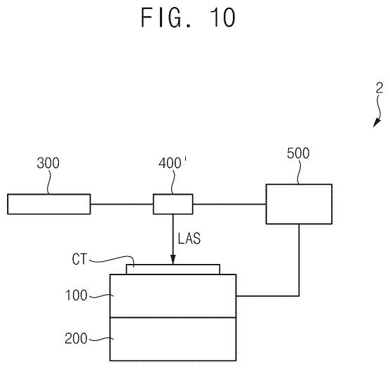

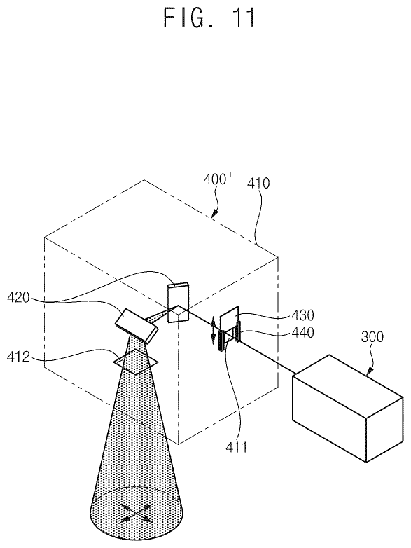

FIG. 10 is a view illustrating a laser apparatus according to an embodiment of the present disclosure. FIG. 11 is a view illustrating a scanner included in the laser apparatus of FIG. 10.

Referring to FIGS. 10 and 11, a laser apparatus 2 according to an embodiment of the present disclosure may include a stage 100, a work table 200, a laser generating part 300, a scanner 400′, and a control part 500.

The laser apparatus 2 shown in FIGS. 10 and 11 may be substantially the same as the laser apparatus 1 described above with reference to FIGS. 1 to 8, except that the scanner 400′ may further include a shutter 430 for blocking a laser beam LAS. Hereinafter, any repetitive detailed descriptions of the same or like elements as those of the laser apparatus 1 described above with reference to FIGS. 1 to 8 may be omitted or simplified.

In an embodiment, the scanner 400′ may be arranged on an optical path of the laser beam LAS emitted from the laser generating part 300. The scanner 400′ may include a housing 410, a mirror portion 420, a shutter 430, and a shutter driver 440.

The shutter 430 may be arranged on the optical path of the laser beam LAS. The shutter 430 may block the laser beam LAS emitted from the laser generating part 300. That is, the shutter 430 may control the entry of the laser beam LAS into an interior of the housing 410 through an opening and closing operation. In an embodiment, for example, when the shutter 430 is open, the laser beam LAS may enter the interior of the housing 410, and when the shutter 430 is closed, the laser beam LAS may not enter the interior of the housing 410. In an embodiment, as illustrated in FIG. 11, the shutter 430 may be arranged on one surface of the housing 410. However, the present disclosure is not limited thereto, and the shutter 430 may be located inside the housing 410 or outside the housing 410.

The shutter driver 440 may drive the shutter 430. In an embodiment, for example, the shutter driver 440 may drive the shutter 430 in a sliding manner. The shutter driver 440 may be controlled by the control part 500. That is, the shutter driver 440 may receive a shutter control signal from the control part 500, and may open or close the shutter 430 in response to the shutter control signal.

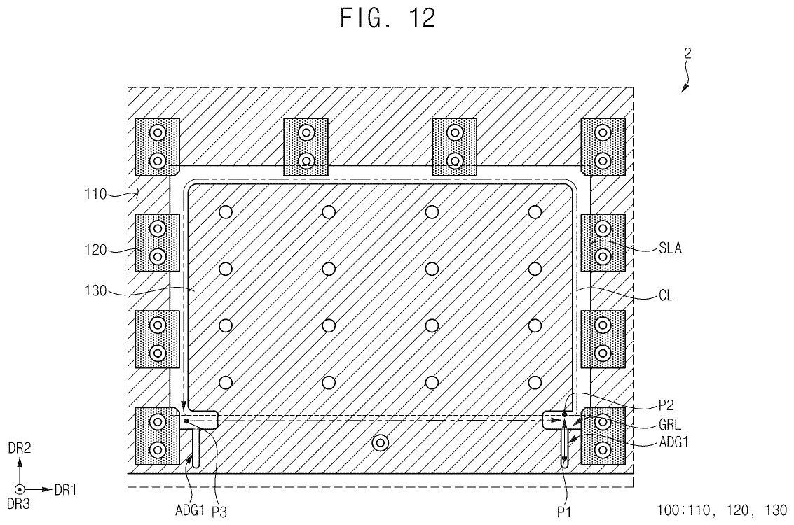

FIG. 12 is a plan view for describing an embodiment of a cutting process using the laser apparatus of FIG. 10. Hereinafter, any repetitive detailed descriptions of the same or like elements as those of the cutting process using the laser apparatus 1 described above with reference to FIG. 9 may be omitted or simplified.

Referring to FIGS. 10, 11, and 12, in an embodiment of a cutting process using the laser apparatus of FIG. 10, before forming a cutting line CL on the object CT, the laser beam LAS may be radiated to a first additional groove line ADG1. In an embodiment, for example, where a second point P2 is a cutting start point of the object CT, a first point P1 of the first additional groove line ADG1 adjacent to the second point P2 may be a point at which the radiation of the laser beam LAS starts.

To perform the process of forming the cutting line CL in a state in which the power of the laser beam LAS is stabilized, the process of forming the cutting line CL may be performed after the laser generating part 300 is turned on for a period (e.g., a predetermined period) of time. The laser beam LAS may be radiated to the first additional groove line ADG1 during the period (e.g., the predetermined period) of time in which the power of the laser beam LAS is stabilized. During the period (e.g., the predetermined period) of time in which the power of the laser beam LAS is stabilized, an aiming point of the laser beam LAS may move in the second direction DR2 from the first point P1.

In a state in which the power of the laser beam LAS is stabilized, the laser beam LAS may be radiated to the second point P2, and the process of forming the cutting line CL at the object CT may be performed. A first end of the cutting line CL may be the second point P2, and a second end opposite to the first end of the cutting line CL may be the third point P3. The laser beam LAS may be radiated along the first short side, the long side, and the second short side to form the cutting line CL, and when the aiming point of the laser beam LAS moves to the third point P3, the process of forming the cutting line CL at the object CT may be terminated.

In an embodiment, when the aiming point of the laser beam LAS moves to the third point P3, the laser generating part 300 may be still turned on. In a state where the laser generating part 300 is turned on, the aiming point of the laser beam LAS may move from the third point P3 to the second point P2. That is, the laser generating part 300 may continue to emit the laser beam LAS while the aiming point of the laser beam LAS moves from the third point P3 to the second point P2.

In such an embodiment, the shutter 430 of the scanner 400′ may be closed while the aiming point of the laser beam LAS moves from the third point P3 to the second point P2 to effectively prevent the stage 100 from being damaged by the laser beam LAS emitted from the laser generating part 300. That is, while the aiming point of the laser beam LAS moves from the third point P3 to the second point P2, the control part 500 may control the shutter driver 440, and the shutter driver 440 may close the shutter 430. As the shutter driver 440 closes the shutter 430, even though the laser generating part 300 emits the laser beam LAS, the laser beam LAS may not be radiated to the stage 100.

After the aiming point of the laser beam LAS moves from the third point P3 to the second point P2, the shutter driver 440 may open the shutter 430. As the shutter driver 440 opens the shutter 430, the laser beam LAS may be radiated to the second point P2, and the process of forming the cutting line CL at the object CT may be performed again.

In such an embodiment, as described above, the laser generating part 300 of the laser apparatus 2 may be continuously turned on even after the process of forming the cutting line CL is terminated. Accordingly, the process of stabilizing the power of the laser beam LAS may be performed only once when the laser generating part 300 is first turned on, and the process of forming the cutting line CL at the object CT may be performed repeatedly.

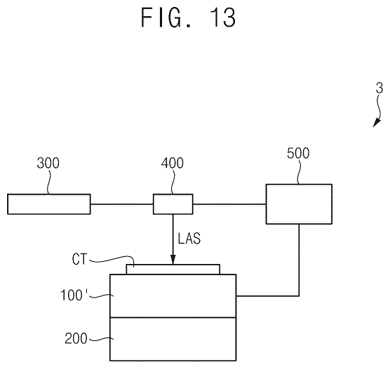

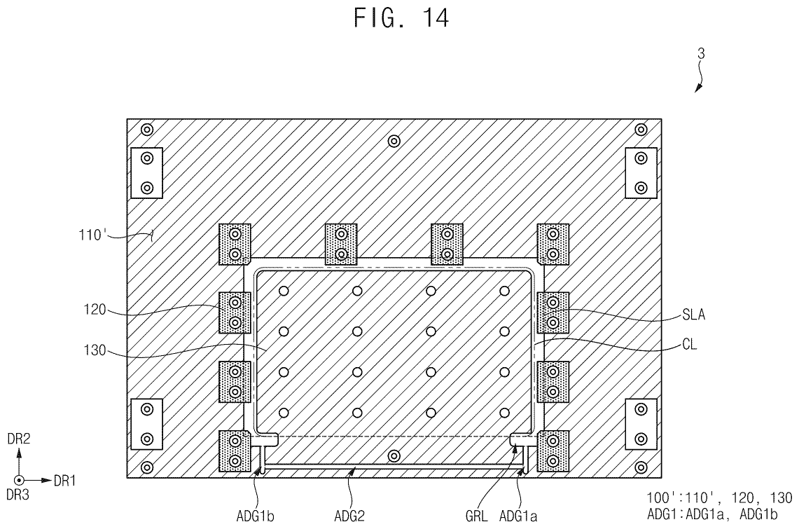

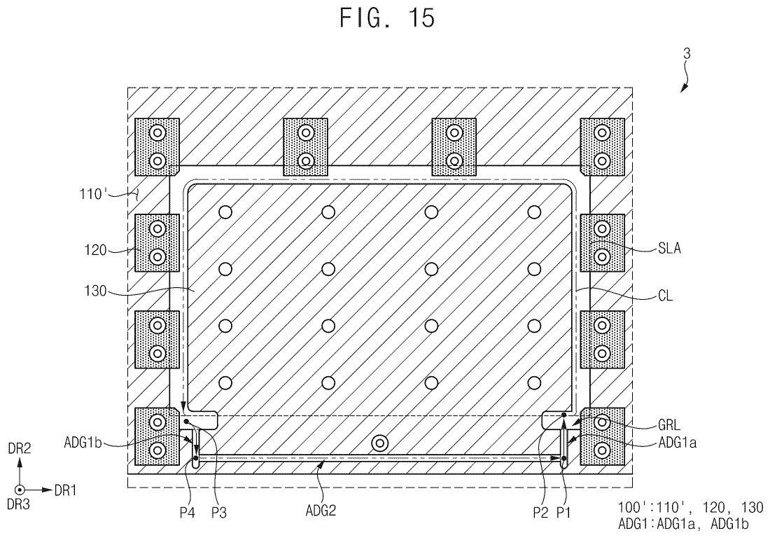

FIG. 13 is a view illustrating a laser apparatus according to an embodiment of the present disclosure. FIG. 14 is a plan view illustrating a stage included in the laser apparatus of FIG. 13.

Referring to FIGS. 13 and 14, a laser apparatus 3 according to an embodiment of the present disclosure may include a stage 100′, a work table 200, a laser generating part 300, a scanner 400, and a control part 500.

The laser apparatus 3 shown in FIGS. 13 and 14 may be substantially the same as the laser apparatus 1 described above with reference to FIGS. 1 to 8, except that a second additional groove line ADG2 is further defined on an upper surface of the stage 100′. Hereinafter, any repetitive detailed descriptions of the same or like elements as those of the laser apparatus 1 described above with reference to FIGS. 1 to 8 may be omitted or simplified.

In an embodiment, the stage 100′ may include a body portion 110′, a peripheral supporting portion 120, and a central supporting portion 130.

A groove line GRL may be defined on an upper surface of the body portion 110′. The groove line GRL may be defined or formed between the peripheral supporting portion 120 and the central supporting portion 130. The groove line GRL may entirely overlap the cutting line CL in a plan view. As the groove line GRL is formed on the upper surface of the body portion 110′, the stage 100′ may be effectively prevented from being damaged by a laser beam LAS in the process of forming a cutting line CL at the object CT.

In an embodiment, a first additional groove line ADG1 may be defined on the upper surface of the body portion 110′. The first additional groove line ADG1 may be formed at a periphery of the groove line GRL, and may be spatially connected to the groove line GRL. In an embodiment, the first additional groove line ADG1 may be integrally formed with the groove line GRL as a single unitary indivisible part. In an embodiment, for example, the first additional groove line ADG1 may extend in the second direction DR2.

The first additional groove line ADG1 may be spaced apart from the cutting line CL. Before the process of forming the cutting line CL at the object CT, the laser beam LAS may be radiated to the first additional groove line ADG1 while the power of the laser beam LAS is stabilized. As the first additional groove line ADG1 is formed on the upper surface of the body portion 110′, the stage 100′ may be effectively prevented from being damaged by the laser beam LAS in the process of radiating the laser beam LAS to the first additional groove line ADG1.

In an embodiment, the first additional groove line ADG1 may be provided in plurality, and the plurality of the first additional groove lines ADG1 may be spatially connected to one side of the groove line GRL and the opposite side opposite to the one side of the groove line GRL in the first direction DR1, respectively. In an embodiment, for example, the first additional groove lines ADG1 may include a first first additional groove line (hereinafter, will be referred to as “(1-1)-th additional groove line”) ADG1a spatially connected to the one side of the groove line GRL and a second first additional groove line (hereinafter, will be referred to as “(1-2)-th additional groove line”) ADG1b spatially connected to the other side of the groove line GRL. The (1-1)-th additional groove line ADG1a and the (1-2)-th additional groove line ADG1b may be spaced apart from each other in the first direction DR1.

In an embodiment, the second additional groove line ADG2 may be defined on the upper surface of the body portion 110′. The second additional groove line ADG2 may be defined as a line of grooves dug to a depth (e.g., a predetermined depth) at the upper surface of the body portion 110′. In an embodiment, the second additional groove line ADG2 may be defined by recessed portion of the stage 100′ in the thickness direction of the stage 100′ (e.g., the third direction DR3).

The second additional groove line ADG2 may be defined or formed at a periphery of the first additional groove line ADG1. In an embodiment, the second additional groove line ADG2 may be formed between the (1-1)-th additional groove line ADG1a and the (1-2)-th additional groove line ADG1b. The second additional groove line ADG2 may be spatially connected to each of the (1-1)-th additional groove line ADG1a and the (1-2)-th additional groove line ADG1b. In other words, the second additional groove line ADG2 may connect the (1-1)-th additional groove line ADG1a and the (1-2)-th additional groove line ADG1b. In ani embodiment, for example, the second additional groove line ADG2 may extend in the first direction DR1. In an embodiment, the second additional groove line ADG2 may be integrally formed with the groove line GRL, the (1-1)-th additional groove line ADG1a, and the (1-2)-th additional groove line ADG1b as a single unitary indivisible part.

The second additional groove line ADG2 may be spaced apart from the cutting line CL. In addition, the second additional groove line ADG2 may be spaced apart from the substrate loading area SLA. While an aiming point of the laser beam LAS moves from a cutting end point (e.g., a point P3 of FIG. 15) of the object CT to a cutting start point (e.g., a point P2 of FIG. 15) of the object CT, the laser beam LAS may be radiated to the second additional groove line ADG2. A detailed description thereof will be provided below with reference to FIG. 15. In such an embodiment, as the second additional groove line ADG2 is formed on the upper surface of the body portion 110′, the stage 100′ may be effectively prevented from being damaged by the laser beam LAS in the process of radiating the laser beam LAS to the second additional groove line ADG2.

In an embodiment, the second additional groove line ADG2 may also include at least one inclined surface (e.g., the inclined surface ICS of FIG. 7) in a cross-section as described above.

FIG. 15 is a plan view for describing a cutting process using the laser apparatus of FIG. 13. Hereinafter, any repetitive detailed descriptions of the same or like elements as those of the cutting process using the laser apparatus 1 described above with reference to FIG. 9 may be omitted or simplified.

Referring to FIGS. 13, 14, and 15, in an embodiment of a cutting process using the laser apparatus of FIG. 13, before forming the cutting line CL at the object CT, the laser beam LAS may be radiated to the first additional groove line ADG1. In an embodiment, for example, where the second point P2 is a cutting start point of the object CT, a first point P1 of the first additional groove line ADG1 adjacent to the second point P2 may be a point at which the radiation of the laser beam LAS starts.

To perform the process of forming the cutting line CL in a state in which the power of the laser beam LAS is stabilized, the process of forming the cutting line CL may be performed after the laser generating part 300 is turned on for a period (e.g., a predetermined period) of time. The laser beam LAS may be radiated to the first additional groove line ADG1 during the period (e.g., the predetermined period) of time in which the power of the laser beam LAS is stabilized. During the period (e.g., the predetermined period) of time in which the power of the laser beam LAS is stabilized, the aiming point of the laser beam LAS may move in the second direction DR2 from the first point P1.

In a state in which the power of the laser beam LAS is stabilized, the laser beam LAS may be radiated to the second point P2, and the process of forming the cutting line CL at the object CT may be performed. A first end of the cutting line CL may be the second point P2, and a second end opposite to the first end of the cutting line CL may be the third point P3. The laser beam LAS may be radiated along the first short side, the long side, and the second short side to form the cutting line CL, and when the aiming point of the laser beam LAS moves to the third point P3, the process of forming the cutting line CL at the object CT may be terminated. That is, the third point P3 may be referred to as a cutting end point.

In an embodiment, when the aiming point of the laser beam LAS moves to the third point P3, the laser generating part 300 may be still turned on. In a state where the laser generating part 300 is turned on, the aiming point of the laser beam LAS may move from the first additional groove line ADG1 adjacent to the third point P3 to the first additional groove line ADG1 adjacent to the second point P2. In an embodiment, for example, when the laser generating part 300 is turned on, the aiming point of the laser beam LAS may move from the third point P3 to a fourth point P4 and then to the first point P1. That is, while the aiming point of the laser beam LAS moves from the first additional groove line ADG1 adjacent to the third point P3 to the first additional groove line ADG1 adjacent to the second point P2, the laser generating part 300 may continue to emit the laser beam LAS.

In such an embodiment, the laser beam LAS may be radiated to the second additional groove line ADG2 while the aiming point of the laser beam LAS moves from the first additional groove line ADG1 adjacent to the third point P3 to the first additional groove line ADG1 adjacent to the second point P2 to prevent the stage 100′ from being damaged by the laser beam LAS emitted from the laser generating part 300. That is, while the aiming point of the laser beam LAS moves from the first additional groove line ADG1 adjacent to the third point P3 to the first additional groove line ADG1 adjacent to the second point P2, the laser beam LAS may be radiated along the second additional groove line ADG2 (e.g., along the first direction DR1).

When the aiming point of the laser beam LAS moves to the first additional groove line ADG1 adjacent to the second point P2, the aiming point of the laser beam LAS may move again toward the second point P2. Accordingly, the laser beam LAS may be radiated to the second point P2, and the process of forming the cutting line CL at the object CT may be performed again.

In such an embodiment, the laser generating part 300 of the laser apparatus 3 may be continuously turned on even after the process of forming the cutting line CL is terminated. Accordingly, the process of stabilizing the power of the laser beam LAS may be performed only once when the laser generating part 300 is first turned on, and the process of forming the cutting line CL at the object CT may be performed repeatedly.

In such an embodiment, the scanner 400 of the laser apparatus 3 may radiate the laser beam LAS to the second additional groove line ADG2 while the aiming point of the laser beam LAS moves from the cutting end point (e.g., the third point P3) to the cutting start point (e.g., the second point P2). As the laser beam LAS is radiated to the second additional groove line ADG2, the stage 100′ may be effectively prevented from being damaged by the laser beam LAS, and the laser generating part 300 of the laser apparatus 3 may continuously emit the laser beam LAS while moving from the cutting end point to the cutting start point without using the shutter (430, refer to FIG. 11). That is, the laser apparatus 3 may effectively prevent the stage 100′ from being damaged due to malfunction of the shutter and the shutter driver (440, refer to FIG. 11).

Embodiments of the present disclosure may be applied to various display devices, for example, display devices for vehicles, ships and aircraft, portable communication devices, display devices for exhibition or information transmission, medical display devices, and the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A laser apparatus comprising:
a stage on which an object is loaded, wherein the stage defines a groove line which entirely overlaps a cutting line of the object in a plan view, and a first additional groove line which is at a periphery of the groove line, is spatially connected to the groove line, and is spaced apart from the cutting line in the plan view;
a laser generating part which is arranged on the stage and emits a laser beam; and
a scanner which is arranged on an optical path of the laser beam and radiates the laser beam toward the object.

2. The laser apparatus of claim 1, wherein when the laser generating part is turned on from a turned-off state, the scanner radiates the laser beam to the first additional groove line.

3. The laser apparatus of claim 1, wherein before forming the cutting line at the object, the scanner radiates the laser beam to the first additional groove line during a period of time in which a power of the laser beam is stabilized.

4. The laser apparatus of claim 1,
wherein the first additional groove line is provided in plurality, and
wherein a plurality of first additional groove lines are spatially connected to one side of the groove line and an opposite side opposite to the one side of the groove line, respectively.

5. The laser apparatus of claim 1, wherein surfaces of the stage defining the first additional groove line comprises an inclined surface in a cross-section.

6. The laser apparatus of claim 1, wherein inner side surfaces of the stage defining the first additional groove line comprises an uneven structure.

7. The laser apparatus of claim 1, further comprising:
a control part which controls the scanner,
wherein the scanner comprises a shutter which blocks the laser beam emitted from the laser generating part and a shutter driver which controls the shutter to open or close in response to a signal provided from the control part.

8. The laser apparatus of claim 7,
wherein the scanner radiates the laser beam to the groove line from a cutting start point to a cutting end point along the cutting line, and
wherein the shutter blocks the laser beam while an aiming point of the laser beam moves from the cutting end point to the cutting start point.

9. The laser apparatus of claim 1, further comprising:
a work table arranged under the stage and comprising a suction member which applies a suction force to the stage.

10. The laser apparatus of claim 1, wherein the stage comprises:
a body portion defining the groove line and the first additional groove line;
a central supporting portion which is formed integrally with an upper surface of the body portion as a single unitary indivisible part and supports a central portion of the object; and
a peripheral supporting portion which is arranged on the upper surface of the body portion to surround at least a portion of the central supporting portion in the plan view, and supports an edge portion of the object.

11. A laser apparatus comprising:
a stage on which an object is loaded, wherein the stage defines a groove line which entirely overlaps a cutting line of the object in a plan view, a first additional groove line which is at a periphery of the groove line, is spatially connected to the groove line, and is spaced apart from the cutting line in the plan view, and a second additional groove line at a periphery of the first additional groove line;
a laser generating part which is arranged on the stage and emits a laser beam; and
a scanner which is arranged on an optical path of the laser beam and radiates the laser beam toward the object,
wherein the scanner radiates the laser beam to the groove line from a cutting start point to a cutting end point along the cutting line, and
wherein the scanner radiates the laser beam to the second additional groove line while an aiming point of the laser beam moves from the cutting end point to the cutting start point.

12. The laser apparatus of claim 11, wherein when the laser generating part is turned on from a turned-off state, the scanner radiates the laser beam to the first additional groove line.

13. The laser apparatus of claim 11, wherein before forming the cutting line at the object, the scanner radiates the laser beam to the first additional groove line during a period of time in which a power of the laser beam is stabilized.

14. The laser apparatus of claim 11, wherein surfaces of the stage defining the second additional groove line comprises an inclined surface in a cross-section.

15. The laser apparatus of claim 11,
wherein the second additional groove line extends in a first direction, and
wherein the first additional groove line extends in a second direction intersecting the first direction.

16. The laser apparatus of claim 11,
wherein the first additional groove line is provided in plurality, and
wherein a plurality of first additional groove lines comprises a first first additional groove line spatially connected to one side of the groove line and a second first additional groove line spatially connected to an opposing side opposite to the one side of the groove line.

17. The laser apparatus of claim 16,
wherein the first first additional groove line and the second first additional groove line are spaced apart from each other, and
wherein the second additional groove line connects the first first additional groove line and the second first additional groove line.

18. The laser apparatus of claim 11, wherein surfaces of the stage defining the first additional groove line comprises at an inclined surface in a cross-section.

19. The laser apparatus of claim 11, wherein the stage comprises:
a body portion defining the groove line, the first additional groove line, and the second additional groove line;
a central supporting portion which formed integrally with an upper surface of the body portion as a single unitary indivisible part and supports a central portion of the object; and
a peripheral supporting portion which is arranged on the upper surface of the body portion to surround at least a portion of the central supporting portion in the plan view, and supports an edge portion of the object.

20. The laser apparatus of claim 11, further comprising:
a work table arranged under the stage and comprising a suction member which applies a suction force to the stage; and
a control part which controls the scanner.
